(19) United States
(12) Patent Application Publication
(10) Pub. No.: US 2006/0146909 A1
(43) Pub. Date: Jul. 6, 2006

(54) Fiber optic temperature sensor

(76) Inventors: Theodore F Morse, Boston, MA (US); Fei Luo, Quincy, MA (US)

Correspondence Address: WEINGARTEN, SCHURGIN, GAGNEBIN & LEBOVICI LLP, TEN POST OFFICE SQUARE, BOSTON, MA, 02109, US

(21) Appl. No.: 10/535,680

(22) PCT Filed: Nov. 21, 2003
(86) PCT No.: PCT/US03/37303

§ 371 Date: Nov. 20, 2005

Related U.S. Application Data
(60) Provisional application No. 60/428,099, filed on Nov. 21, 2002.

(51) Int. Cl. G01J 5/00

(52) U.S. Cl. 374/130

(57) ABSTRACT

A fiber optic temperature sensor (10) and system employ optical (fiber 34) and a fiber Bragg grating (36) using non-silica materials that can withstand temperature ranges extending well above the silica-imposed limit of 1,100 degrees C. The system measures the wavelength shift of light reflected from the fiber Bragg grating (36) and converts it into a temperature value. Specific optical fibers include sapphire, which can be used at temperatures approaching 1,800 degrees C., and yttria-stabilized zirconia (YSZ), which can be used at temperature in excess of 2,300 degrees C. One specific grating employs alternating layers of YSZ, with the percentage of yttria varying in the alternating layers to achieve the desired difference of refractive index, and another grating employs alternating layers of alumina and zirconia.

### CROSS REFERENCE TO RELATED APPLICATIONS

This application claims priority under 35 U.S.C. §119(e) of U.S. Provisional Patent Application No. 60/428,099 filed Nov. 21, 2002, the disclosure of which is hereby incorporated by reference herein.

### STATEMENT REGARDING FEDERALLY SPONSORED RESEARCH OR DEVELOPMENT

This invention was made with Government support under contract no. N00014-97-G011 awarded by the Department of the Navy, and from the Air Force Office of Scientific Research, under contract number ______. The Government has certain rights in the invention.

### BACKGROUND OF THE INVENTION

The present invention relates to the field of temperature measurement devices and techniques based on optical technology.

In many high temperature processes, it is important to have accurate knowledge of temperature, for example to maximize efficiency. This is true for processes such as materials processing in the metal and glass industries, and is equally true in the measurement of turbine inlet temperatures in jet engines and in stationary gas turbine power plants. However, the maximum temperatures in these processes can reach as high as 1,700 to 2,300° C. Ordinary thermocouples cannot meet the requirements for stable and accurate operation in such high-temperature applications.

It has been shown that temperature sensors based on optical technology may be employed to achieve certain benefits not possessed by conventional thermocouples. An optical thermocouple includes a silica glass fiber, one end of which terminates in a so-called fiber Bragg grating. In one known configuration, the fiber Bragg grating is composed of alternating layers of silicon nitride and silicon-rich silicon nitride. The fiber Bragg grating responds to changes in temperature by corresponding changes in the spectral content of reflected light, specifically by a change in the optical wavelength at which peak reflectivity occurs. This response can be exploited for use in a an optical temperature measurement system.

A measurement system can be built in which broadband optical energy is transmitted along an optical fiber toward one end at which a fiber Bragg grating is formed. The fiber Bragg grating is disposed in an environment whose temperature is to be measured. A broadband optical spectrum analyzer is also coupled to the fiber to receive optical energy reflected from the fiber Bragg grating. By analyzing the output from the optical spectrum analyzer, it is possible to determine the amount of wavelength shift of the peak of the reflectivity characteristic, and then to convert this peak shift into a temperature value.

Optical-based temperature measurement systems such as those described above have several advantages, including the ability to withstand high temperatures and immunity from electrical noise due to their all-dielectric construction. With respect to temperature, however, silica-based fiber and fiber Bragg gratings are generally limited to use at temperatures less than about 1,100° C. It would be desirable to have an optical-based measurement system that permits the measurement of much higher temperatures such as those encountered in the industrial and turbine applications described above.

### BRIEF SUMMARY OF THE INVENTION

In accordance with the present invention, a fiber optic temperature sensor and system are disclosed that achieve the benefits of optical temperature sensing at much higher temperatures than have heretofore been possible, thus enabling the accurate measuring of temperature in a variety of high-temperature applications.

The disclosed sensor and system employ optical fiber and fiber Bragg gratings using non-silica materials that can withstand temperature ranges well above the silica-imposed limit of 1,100° C. In one embodiment, the use of sapphire optical fiber enables use of the sensor at temperatures approaching 1,800° C., while an alternative sensor employing yttria-stabilized zirconia is capable of use at temperatures in excess of 2,350° C. These high-temperature fibers are used in conjunction with fiber Bragg gratings made of materials that can also withstand such temperatures. In one case, the grating employs alternating layers of yttria stabilized zirconia, with the percentage of yttria varying in the alternating layers to achieve the desired difference of refractive index. Alternatively, alternating layers of alumina and zirconia can be employed.

The dynamic range of this device is extremely wide, and can be as low as liquid nitrogen temperatures. Unlike black body or pyrometer type devices, there is no dependence upon limiting low photon flux at low temperatures.

Other aspects, features, and advantages of the present invention will be apparent from the Detailed Description that follows.

### BRIEF DESCRIPTION OF THE SEVERAL VIEWS OF THE DRAWINGS

The invention will be more fully understood by reference to the following Detailed Description of the invention in conjunction with the Drawing, of which:

FIG. 1 is a block diagram of an optical temperature measurement system in accordance with the present invention;

FIG. 2 is a cross-sectional view of a high-temperature optical probe used in the measurement system of FIG. 1;

FIG. 3 is a plot of representative curves of reflectance versus wavelength for a fiber Bragg grating such as used in the optical probe of FIG. 2;

FIG. 4 is a plot of representative values of wavelength peak shift versus temperature for a fiber Bragg grating such as used in the optical probe of FIG. 2;

FIG. 5 is a flow diagram of a process for converting raw optical spectrum data from an optical spectrum analyzer into a temperature value in the measurement system of FIG. 2; and

FIG. 6 is a plot illustrating the calculation of a fine part of wavelength shift in the process of FIG. 5.

### DETAILED DESCRIPTION OF THE INVENTION

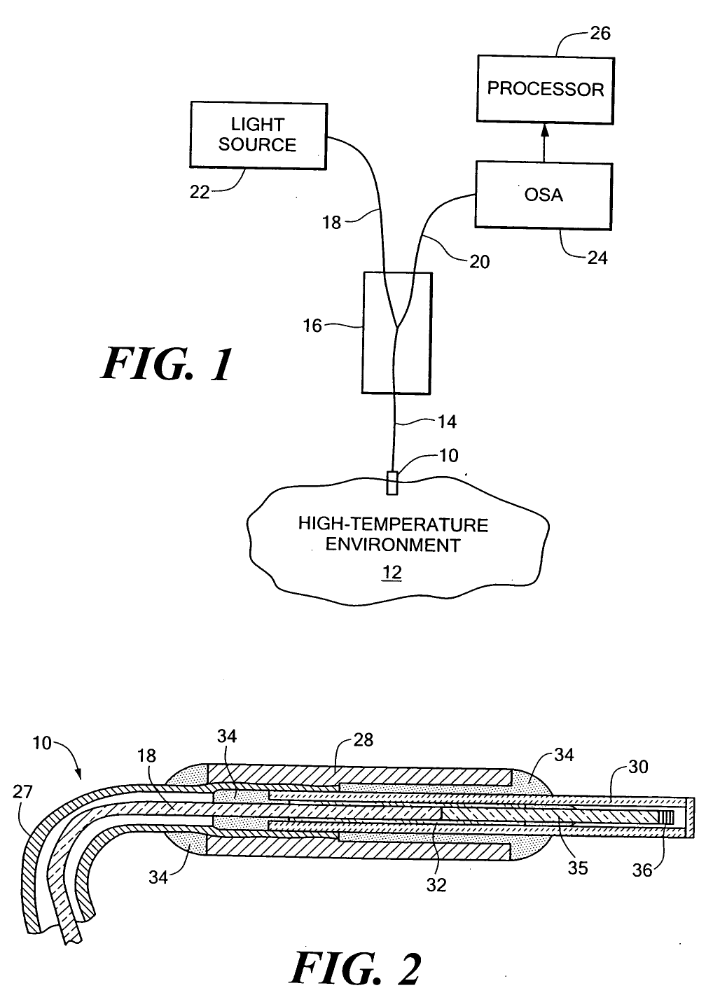

FIG. 1 illustrates a temperature measurement system employing an optical-fiber-based probe 10 disposed in a high-temperature environment 12. The high-temperature environment 12 may exhibit a temperature range from −200° C. to 2,350° C., the upper end of which is considerably higher than the maximum temperatures that may be directly measured using conventional means. Examples of such high-temperature environments 12 include material processes (such as the manufacture of ceramics), gas turbine inlet streams (such as jet engines or power plants), rocket nozzle exhaust streams, and space applications, etc.

Extending from the probe 10 is an optical fiber 14. An optical coupler 16 joins the probe fiber 14 to two additional fibers 18, 20. The fiber 18 carries light from a broadband light source 22 to the probe 10 via the coupler 16, and the fiber 20 carries reflected light from the probe 10 to an optical spectrum analyzer (OSA) 24, which may be for example a charge-coupled device (CCD) array. The electrical outputs of the OSA 24 are coupled to a digital processor 26.

The broadband light source 22 can be implemented by a LED or other suitable broadband source. The range of optical wavelengths from the source 22 encompasses a range of reflectance frequencies of a fiber Bragg grating employed within the probe 10, which is described in more detail below.

FIG. 2 shows the probe 10 in detail. The optical fiber 18 is encased in a flexible metal jacket 27 and extends into a probe body including an outer sleeve 28 of ceramic or metal, an elongated inner ceramic sleeve 30, and an inner quartz sleeve 32. The ends of the probe body are sealed with high temperature cement 34. The optical fiber 18, which is typically silica, is butt-joined to a tip optical fiber 34 of a material capable of withstanding extremely high temperatures. Examples of such a material include sapphire and yttria-stabilized zirconia. Preferably the fibers 18 and 34 are coupled using an anti-reflective coating to reduce undesirable optical reflections and losses.

Formed at the distal end of the tip optical fiber 34 is a 1/4-wavelength fiber Bragg grating 36, which is used as a wavelength-selective reflector. The grating can be made using different types of ceramic systems. In one scheme, the grating 36 is made using yttria-stabilized zirconia, with alternating layers having different concentrations of yttria to achieve the small difference of refractive index that is required for a narrow reflecting structure. The percentage of yttria doping can be from, typically, 5% to 40%. This structure retains its chemical stability when subjected to temperatures as high as 2400° C. Also, the thermal expansion properties of such layers are well matched, minimizing destructive thermal-induced mechanical strain. This is extremely important.

As an alternative, alternating layers of alumina and zirconia can be employed. It may be desirable to add yttria to the zirconia layers to improve the refractive index matching between the two layers. A layer having 20% yttrium has a refractive index of 1.9, which is close to the refractive index of 1.76 of alumina.

The grating 36 can be formed using a process in which a layer is deposited at the end of the fiber 18 while the reflectance at a particular wavelength is monitored. The reflectance will vary between a maximum and a minimum as each layer is deposited. When a peak or valley of the reflectance is reached during the deposition of one layer, the deposition is stopped and the deposition of the next layer is begun. This process is repeated until the desired number of layers have been deposited.

Additionally, it is possible to form the grating 36 using other combinations of repeating sequences of materials of different refractive indices that will provide high reflectivity over a narrow wavelength region.

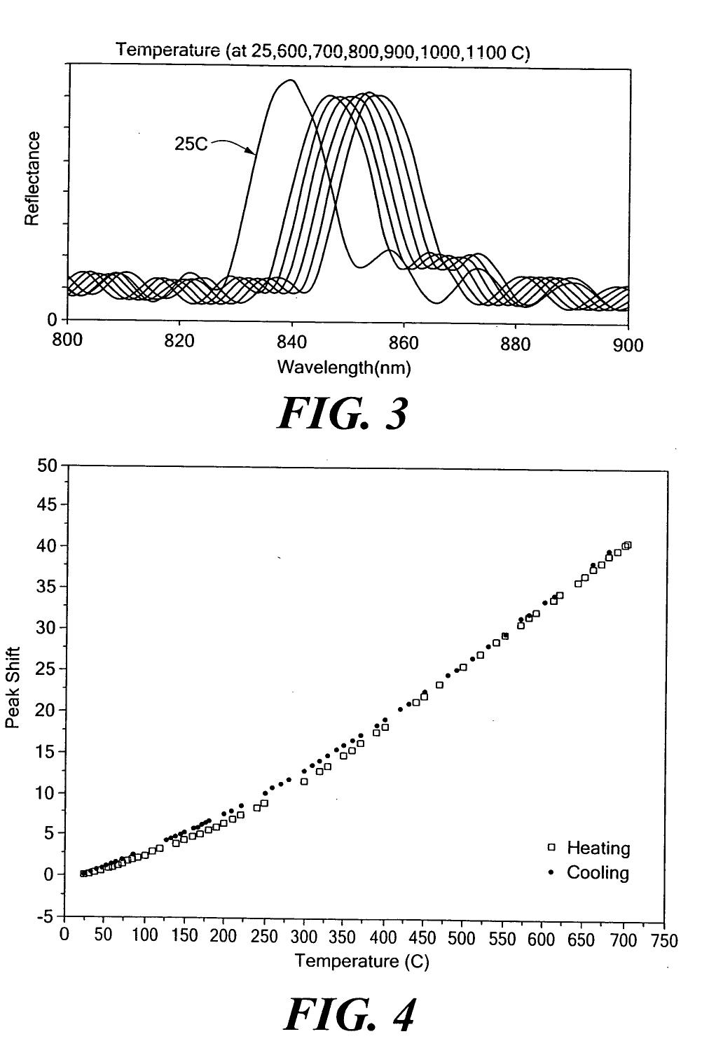

FIG. 3 generally illustrates the variation of reflectance with temperature of a fiber Bragg grating such as grating 36. The particular curves shown in FIG. 3 are representative of a fiber Bragg grating employing alternating layers of silicon nitride and silicon-rich silicon nitride, but it is expected that similar results will be obtained for fiber Bragg gratings of the type described above.

As shown in FIG. 3, the reflectance of the grating at a given temperature will exhibit a peak at a particular wavelength. In FIG. 3, the peak reflectivity is about 84%. The horizontal location of this peak will shift as the temperature of the grating changes. This is shown in FIG. 3 as a horizontal shifting of the reflectance-versus-wavelength curve. It is also shown in FIG. 4 as a scatter plot of peak shift versus temperature, under conditions of heating as well as cooling. The vertical units of FIG. 4 are CCD pixels in the OSA 24. It will be observed from FIG. 4 that the dependence of peak shift on temperature is almost linear, and exhibits almost no hysteresis. In the example shown in FIG. 3, the peak occurs at about 840 nm at 25° C., and shifts to approximately 855 nm at 1100° C. By measuring the amount of the peak shift from some predetermined calibrated position, the temperature of the grating, and thus of the environment immediately surrounding the grating, can be accurately determined.

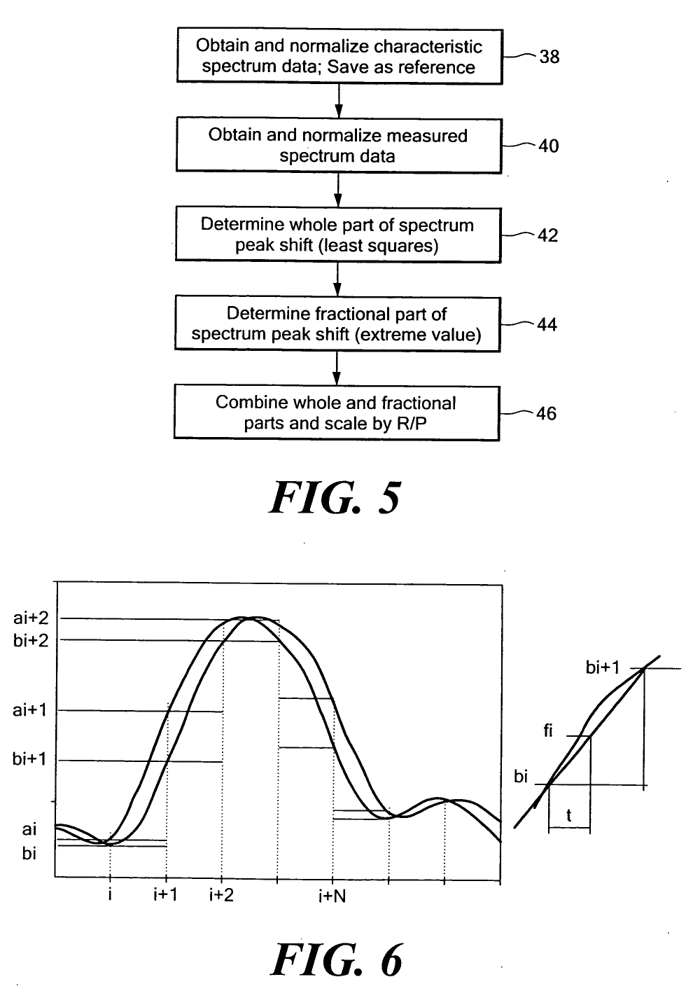

FIG. 5 shows a process for obtaining temperature measurements from the probe 36 based on the peak shift of reflected light. In step 38, the probe 36 is placed in an environment of known temperature, and the characteristic spectrum data is obtained from the OSA 24, normalized, and saved as a reference spectrum. This normalization takes the following form:

$$\overleftrightarrow{Y} = \frac{( N + 1 ) \overleftrightarrow{X} - {\sum }_{i = 0}^{N} xi}{\sqrt{{\vert {\sum }_{i = 0}^{N} ( ( N + 1 ) xi - {\sum }_{i = 0}^{N} xi ) )}^{2} \vert}}$$

where X represents the raw spectrum data vector and Y represents the normalized data vector. To facilitate subsequent processing, only the main portion of the spectrum containing the peak is utilized. This vector can be represented as
A=[aᵢ, aᵢ₊₁, . . . , a_{i+N})

In step 40, measured spectrum data is obtained at an unknown temperature being measured, and this data is normalized using the same normalization function described above. To facilitate the analysis steps to follow, the normalized measured spectrum data is saved as an array of sub-vectors of the overall vector output of the OSA 24. These can be represented as follows:

$${B}_{0} = [ {b}_{i} , {b}_{i + 1} , … , {b}_{i + N} )$$

$$⋮$$

$${B}_{k} = [ {b}_{i + k} , {b}_{i + k + 1} , … , {b}_{i + k + N} )$$

$$⋮$$

$${B}_{m} = [ {b}_{i + m} , {b}_{i + m + 1} , … , {b}_{i + m + N} )$$

where m represents an assumed maximum pixel shift of the measured characteristic spectrum, which corresponds to the highest temperature to be read by the probe 36.

At step 42, the “whole” part h of the spectrum peak shift (in integer number of pixels or CCD elements) is determined using a least squares algorithm on the reference and measured spectrums. This involves computing a measure of the difference between the normalized reference spectrum vector and each of the normalized measured spectrum vectors, and then determining which of the computed difference values is the smallest. This algorithm can be expressed as follows:

1. For k=0 to k=m, calculate:

$$\begin{matrix}{d}_{k} = ( A - {B}_{k} ) * ( A - {B}_{k} ) \\ = {\sum }_{n = 0}^{N} {( {a}_{i} - {b}_{i + k + n} )}^{2}\end{matrix}$$

2. Find the minimum dₖ, which is denoted dₕ. The value h is the whole part of the peak shift.

In step 44, the fractional part t of the peak shift is determined. This preferably uses an “extreme value” calculation, which is described with reference to FIG. 6. FIG. 6 shows the relationship of several values used in the calculation, namely aᵢ, bᵢ, aᵢ₊₁, bᵢ₊₁, etc. The calculation uses the following equation:

$$t = \frac{{\sum }_{n = 0}^{N} [ ( {a}_{i + n} - {b}_{i + h + n} ) ( {b}_{i + h + n + 1} - {b}_{i + h + n} ) ]}{{\sum }_{n = 0}^{N} {( {b}_{i + h + n + 1} - {b}_{i + h + n} )}^{2}}$$

Finally, in step 46, the spectral shift is calculated as
S_{shift}=Wₚᵢₓₑₗ*Sₚᵢₓₑₗ,
where
Sₚᵢₓₑₗ=h+t

and Wₚᵢₓₑₗ is equal to the per-pixel spectral width of the OSA 24. If linearity is assumed, the value Wₚᵢₓₑₗ can be calculated by dividing the total spectral width of the OSA 24 by the number of pixels (CCD elements) in the array.

The value S_{shift} can then be translated to a temperature using a pre-computed conversion factor obtained during a calibration process. This factor has units of degrees/(nm of wavelength), and thus yields a temperature in degrees when multiplied by S_{shift}. In one type of calibration process, the steps of FIG. 5 are performed at two temperatures of known separation, and the conversion factor is then calculated by dividing the known temperature separation by the value of S_{shift} that is obtained in the measurement process. For example, a reference measurement can be taken at 25° C., and a second measurement taken at 50° C., providing a known 25° C. difference in temperature. This value is divided by the value of S_{shift} obtained for the second measurement to obtain the conversion factor. It will be appreciated that other techniques for obtaining a conversion factor or a set of conversion factors to be used for temperature measurements can be employed, which might account for non-linearities in the temperature-vs.-wavelength characteristic of the system.

As an example of the use of the conversion factor, if it is assumed that the conversion factor is 15° C. per nm, then a value of S_{shift}=37.6 yields a measured temperature T of

$$\begin{matrix}T = 25 + ( 15 ) ( 37.6 ) \\ = 589 ° C .\end{matrix}$$

It will be apparent to those skilled in the art that modifications to and variations of the disclosed methods and apparatus are possible without departing from the inventive concepts disclosed herein, and therefore the invention should not be viewed as limited except to the full scope and spirit of the appended claims.

1. A fiber optic tmperature sensor for measuring temperatures in a measurement range from less than −200° C. to substantially beyond about 1,100° C., comprising:
a rigid sensor body of a heat-dissipating material;
a hollow tip member extending from the sensor body, the hollow tip member being made of a material capable of withstanding temperatures in the measurement range; and
an optical fiber disposed within the tip member, the optical fiber being made of a material capable of withstanding temperatures in the measurement range, the optical fiber terminating in a selectively reflective fiber Bragg grating made of materials capable of withstanding temperatures in the measurement range.

2. A fiber optic temperature sensor according to claim 1, wherein the optical fiber comprises sapphire.

3. A fiber optic temperature sensor according to claim 1, wherein the optical fiber comprises zirconia.

4. A fiber optic temperature sensor according to claim 3, wherein the zirconia is stabilized with yttria.

5. A fiber optic temperature sensor according to claim 1, wherein the fiber Bragg grating comprises layers of yttria-stabilized zirconia, wherein alternating layers have different concentrations of yttria to provide a desired difference of refractive index.

6. A fiber optic temperature sensor according to claim 1, wherein the fiber Bragg grating comprises alternating layers of alumina and zirconia.

7. A fiber optic temperature sensor according to claim 1, wherein the tip member comprises ceramic.

8. A fiber optic temperature sensor according to claim 1, wherein the sensor body comprises a metal sleeve from which the tip member extends.

9. A fiber optic temperature sensor according to claim 8, wherein the metal sleeve and the tip member of the sensor body are attached together by high-temperature cement.

10. A fiber optic temperature sensor according to claim 8, wherein the metal sleeve comprises copper.

11. A fiber optic temperature sensor according to claim 1, wherein the optical fiber is a first optical fiber, and further comprising a second optical fiber having one end disposed within the sensor body and optically coupled to the first optical fiber.

12. A fiber optic temperature sensor according to claim 11, wherein the second optical fiber is butt-joined to the first optical fiber with an anti-reflective coating interposed therebetween.

13. A fiber optic temperature sensor according to claim 11, wherein the second optical fiber comprises silica.

14. A fiber optic temperature sensor according to claim 11, wherein the second optical fiber is disposed within a rugged jacket, and wherein the jacket is disposed within the sensor body in a manner retaining the second fiber within the sensor body.

15. A fiber optic temperature sensor according to claim 14, wherein the metal sleeve and the tip member of the sensor body are attached together by high-temperature cement.

16. A system for measuring temperatures in a measurement range from less than −200° C. to substantially beyond about 1,100° C., comprising:
a fiber optic temperature sensor having a tip portion with an optical fiber therein, the optical fiber being made of a material capable of withstanding temperatures in the measurement range, the optical fiber terminating in a fiber Bragg grating made of materials capable of withstanding temperatures in the measurement range and having reflectivity which is a function of wavelength of incident light;
a broadband light source being optically coupled to the optical fiber to transmit light along the optical fiber toward the fiber Bragg grating;
an optical spectrum analyzer optically coupled to the optical fiber to receive light reflected from the fiber Bragg grating back into the optical fiber; and
a processor operative to receive one or more electrical signals from the optical spectrum analyzer representing the intensity of the reflected light across an optical spectrum including an optical wavelength at which an optical characteristic of the fiber Bragg grating is detected, the processor being further operative to determine a value of the optical wavelength at which the optical characteristic of the fiber Bragg grating is detected and to convert the determined wavelength value to a temperature value according to predetermined conversion criteria.

17. A temperature-measuring system according to claim 16, wherein the optical fiber comprises sapphire.

18. A temperature-measuring system according to claim 16, wherein the optical fiber comprises zirconia.

19. A temperature-measuring system according to claim 18, wherein the zirconia is stabilized with yttria.

20. A temperature-measuring system according to claim 16, wherein the fiber Bragg grating comprises layers of yttria-stabilized zirconia, wherein alternating layers have different concentrations of yttria to provide a desired difference of refractive index.

21. A temperature-measuring system according to claim 16, wherein the fiber Bragg grating comprises alternating layers of alumina and zirconia.

22. A temperature-measuring system according to claim 16, wherein the optical fiber is a first optical fiber, and further comprising a second optical fiber operative to optically couple the temperature sensor to the light source and the optical spectrum analyzer, the second optical fiber having one end disposed within the temperature sensor and optically coupled to the first optical fiber.

23. A temperature-measuring system according to claim 22, wherein the second optical fiber is butt-joined to the first optical fiber with an anti-reflective coating interposed therebetween.

24. A temperature-measuring system according to claim 22, wherein the second optical fiber comprises silica.

25. A temperature-measuring system according to claim 22, further comprising an optical coupler having one bidirectional optical port coupled to the second optical fiber, the optical coupler having a light input optical port coupled to the light source and a light output optical port coupled to the optical spectrum analyzer.

26. A temperature-measuring system according to claim 16, wherein the optical spectrum analyzer comprises a photodetector array.

27. A temperature-measuring system according to claim 26, wherein the photodetector array comprises a charge-coupled device array.

28. A temperature-measuring system according to claim 16, wherein the optical characteristic is peak reflectivity.

29. A temperature-measuring system according to claim 16, wherein the processor is operative when determining the value of the optical wavelength at which the optical characteristic of the fiber Bragg grating is detected to:
i) obtain and normalize measured spectrum data from the optical spectrum analyzer when the system is operating at a measurement temperature; and
ii) compute an amount by which the normalized measured spectrum data must be shifted in wavelength to yield shifted normalized measured spectrum data in which the optical characteristic is most similar to the same optical characteristic in pre-established reference spectrum data.

30. A temperature-measuring system according to claim 29, wherein computing the amount by which the normalized measured spectrum data must be shifted comprises (i) calculating a difference function of the reference spectrum data and each of shifted versions of the normalized measured spectrum data, and (ii) identifying one of the shifted versions of the normalized measured spectrum data for which the calculated function yields a minimum value.

31. A temperature-measuring system according to claim 30, wherein the difference function comprises a least squares function.

32. A temperature-measuring system according to claim 29, wherein computing the amount by which the normalized measured spectrum data must be shifted comprises (i) determining a whole part representing an integer number of shift units, (ii) determining a fractional part representing a fraction of a shift unit, and (iii) adding the whole and fractional parts together.

33. A temperature-measuring system according to claim 32, wherein determining the whole part comprises computing a least squares difference function of the reference spectrum data and each of shifted versions of the normalized measured spectrum data, and determining the fractional part comprises computing an extreme value function of the reference spectrum data and one of the shifted versions of the normalized measured spectrum data for which the least squares function yields a minimum value.

34. A temperature-measuring system according to claim 16, wherein the predetermined conversion criteria comprises a multiplicative factor representing a temperature difference per unit of shift.

35. A temperature-measuring system according to claim 34, wherein the multiplicative factor is determined by a calibration process that includes obtaining measured spectrum data at a known temperature different from the reference temperature, and dividing the difference between the known temperature and the reference temperature by an amount by which normalized spectrum data obtained at the known temperature must be shifted in wavelength to yield shifted normalized spectrum data in which the optical characteristic is most similar to the same optical characteristic in the reference spectrum data.

36. In a temperature measurement system employing a fiber optic temperature sensor and an optical spectrum analyzer optically coupled to the temperature sensor, wherein the temperature sensor produces reflected light across an optical spectrum including an optical wavelength at which an optical characteristic of the temperature sensor can be detected, and wherein the optical spectrum analyzer is operative to produce electrical signals representing the intensity of the reflected light from the temperature sensor across the optical spectrum, a method of generating a measured temperature value based on the electrical signals, comprising:
establishing reference spectrum data from the electrical signals when the system is operating at a predetermined reference temperature;
obtaining and normalizing measured spectrum data from the electrical signals when the system is operating at a measurement temperature;
computing an amount by which the normalized measured spectrum data must be shifted in wavelength to yield shifted normalized measured spectrum data in which the optical characteristic is most similar to the same optical characteristic in the reference spectrum data; and
using pre-established conversion criteria to convert the computed shift amount to the measured temperature value.

37. A method according to claim 36, wherein computing the amount by which the normalized measured spectrum data must be shifted comprises (i) calculating a difference function of the reference spectrum data and each of shifted versions of the normalized measured spectrum data, and (ii) identifying one of the shifted versions of the normalized measured spectrum data for which the calculated function yields a minimum value.

38. A method according to claim 37, wherein the difference function comprises a least squares function.

39. A method according to claim 36, wherein computing the amount by which the normalized measured spectrum data must be shifted comprises (i) determining a whole part representing an integer number of shift units, (ii) determining a fractional part representing a fraction of a shift unit, and {iii} adding the whole and fractional parts together.

40. A method according to claim 39, wherein determining the whole part comprises computing a least squares difference function of the reference spectrum data and each of shifted versions of the normalized measured spectrum data, and determining the fractional part comprises computing an extreme value function of the reference spectrum data and one of the shifted versions of the normalized measured spectrum data for which the least squares function yields a minimum value.

41. A method according to claim 36, wherein the pre-established conversion criteria comprises a multiplicative factor representing a temperature difference per unit of shift.

42. A method according to claim 41, wherein the multiplicative factor is determined by a calibration process that includes obtaining measured spectrum data at a known temperature different from the reference temperature, and dividing the difference between the known temperature and the reference temperature by an amount by which normalized spectrum data obtained at the known temperature must be shifted in wavelength to yield shifted normalized spectrum data in which the optical characteristic is most similar to the same optical characteristic in the reference spectrum data.
